(19) United States
(12) Patent Application Publication
(10) Pub. No.: US 2004/0189421 A1
(43) Pub. Date: Sep. 30, 2004

(54) Method and system for generation and homodyne detection

(76) Inventors: Ryszard Szczepanik, Warszawa (PL); Edward Dzieciol, Warszawa (PL)

Correspondence Address: Z. Peter Sawicki, Westman, Champlin & Kelly, Suite 1600, 900 Second Avenue South, Minneapolis, MN, 55402-3319, US

(21) Appl. No.: 10/807,418

(22) Filed: Mar. 23, 2004

(30) Foreign Application Priority Data
Mar. 27, 2003 (PL) P-359376

(51) Int. Cl. H01P 5/12; G01M 15/00

(52) U.S. Cl. 333/122; 324/637

(57) ABSTRACT

The invention solves the problem of generation and homodyne detection. Its main application refers to generation and reception of microwave signals during instantaneous measurement of position and shift of mobile elements especially of rotor units of working turbo-machines during true-time operation. The method based on the selection of equal value of both electrical channels between shunt arm in waveguide T-connection and generation diode in one collinear arm and in the second collinear arm between the same shunt arm and detection diode. The system contains generation diode seating connected through waveguide T-connection with detection diode seating.

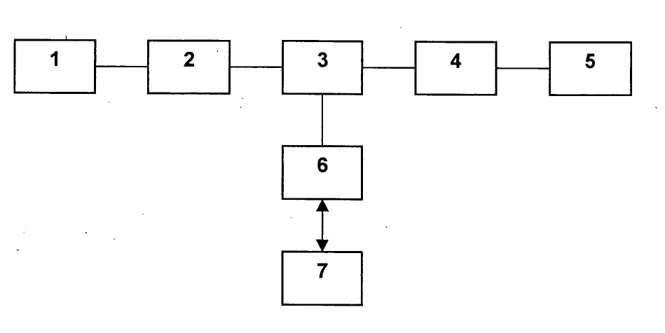

### TECHNICAL FIELD

This invention relates to generation and reception of microwave signals during instantaneous measurement of position and shift of mobile elements especially of rotor units of working turbo-machines during true-time operation.

### BACKGROUND

Accomplishment of already known method exploits the principle of synchronous reception described in “Microwave homodyne systems” by R. J. King, P. Peregrinius LTD, IEE London, 1978. According to this method, the part of power from one generator transmitted by separate microwave channel is compared in detector system with signal from slotted section.

Already known system contains Gunn diode seating connected through collinear arm with magic tee and then by second collinear arm with detection diode seating. Microwave antenna is connected to magnetic magic tee arm and comparative channel is connected to electric magic tee arm.

Both already known method and system make generation and homodyne detection impossible in extremely hard environmental conditions with temperature reaching several hundred degrees centigrade and dynamic pressure as a vibro-acoustic noise reaching about 160 dB. Neither already known method nor system enables operational inspection in such environmental conditions.

### SUMMARY OF THE INVENTION

The method of this invention comprises selection of equal value of both electrical channels between shunt arm in waveguide T-connection and generation diode in one collinear arm and in the second collinear arm between the same shunt arm and detection diode. This means compliance of condition of proper phase location between generation and detection elements.

The system in this invention includes coupling between generating diode seating and detection diode seating by waveguide T-connection (tee).

Method and system of this invention enables operational inspection in each environmental conditions and also enables extending interpretation possibilities of the measurement results.

### DETAILED DESCRIPTION

According to the method, for generation, transmission, reception, and homodyne detection in the range of microwave frequency it is important to ensure the selection of equal value of both electrical channels between shunt arm in waveguide T-connection, and generated diode in one collinear arm, and in the second collinear arm between the same shunt arm and detection diode. That way a compliance condition of proper phase location between generation and detection elements is achieved which is requested for technical embodiment of a microwave homodyne set.

The system is shown in the FIGURE as a bloc diagram. Generation diode seating 1 is connected through collinear arm 2 with coaxial waveguide T-connection 3 and then by collinear arm 4 with detection diode seating 5. Microwave antenna 6 connected to shunt arm of waveguide T-connection 3 radiates and receives signal reflected from inspected object 7.

Although the present invention has been described with reference to preferred embodiments, workers skilled in the art will recognize that changes may be made in form and detail without departing from the spirit and scope of the invention.

What is claimed is:

1. A method of generation and homodyne detection comprising selecting a length of electric path, wherein an equal value is selected of both electrical paths between shunt arm in waveguide T-connection and generated diode in one collinear arm, and in the second collinear arm between the same shunt arm and detection diode.

2. A generation and homodyne detection system containing generation Gunn diode seating connected with one collinear arm, and detection diode seating connected with the second collinear arm significant by waveguide T-connection between generation diode seating and detection diode seating.
